(19) United States
(12) Patent Application Publication
(10) Pub. No.: US 2021/0280887 A1
(43) Pub. Date: Sep. 9, 2021

(54) SYSTEM AND METHOD FOR ELECTROCHEMICAL ENERGY CONVERSION AND STORAGE

(71) Applicants: Guido Pez, Allentown, PA (US); Andrew Michael Herring, Boulder, CO (US)

(72) Inventors: Guido Pez, Allentown, PA (US); Andrew Michael Herring, Boulder, CO (US)

(73) Assignee: Colorado School of Mines

(21) Appl. No.: 17/327,695

(22) Filed: May 22, 2021

Related U.S. Application Data
(62) Division of application No. 15/676,755, filed on Aug. 14, 2017.
(60) Provisional application No. 62/376,233, filed on Aug. 17, 2016.

(51) Int. Cl. H01M 8/1009; H01M 8/18; H01M 8/103; H01M 4/90; H01M 4/92; H01M 8/1004

(52) U.S. Cl. CPC H01M 8/1009; H01M 8/188; H01M 8/103; H01M 2008/1095; H01M 4/926; H01M 8/1004; H01M 4/9083

(57) ABSTRACT

An electrochemical energy conversion and storage system includes an electrochemical energy conversion device, such as a fuel cell that is in fluid communication with a hydrogen or electrically regenerable organic liquid fuel and an oxidant, for receiving, catalyzing and electrochemically oxidizing at least a portion of the fuel to generate electricity, a thus partially oxidized liquid fuel, and water. The liquid fuel includes six-membered ring cyclic hydrocarbons with functional group substituents, wherein the ring hydrogens may undergo an electrochemical oxidative dehydrogenation to the corresponding aromatic molecules. Comprising ring-substituent functional groups may also be electrochemically oxidized now with a potential incorporation of oxygen thus providing an additional capacity for energy storage. The partially oxidized spent liquid fuel may be electrically regenerated in situ with now an input of electricity and water to the device, generating oxygen as a by-product. Alternatively, the recovered spent fuel may be conveyed to a facility where it is reconstituted by catalytic hydrogenation or electrochemical hydrogenation processes.

### CROSS-REFERENCE TO RELATED APPLICATION

This application is a divisional patent application of U.S. patent application Ser. No. 15/676,755, filed on Aug. 14, 2017, which is a continuation-in-part of U.S. Provisional Patent Application Ser. No. 62/376,233, filed Aug. 17, 2016, the disclosure of which is hereby incorporated by reference in its entirety to provide continuity of disclosure to the extent such a disclosure is not inconsistent with the disclosure herein.

### BACKGROUND OF THE INVENTION

The invention relates generally to a system for energy storage and specifically to materials, methods and apparatus for electrochemical energy conversion and storage using a hydrogen or electrically regenerable liquid fuel.

Many electrochemical energy conversion and storage devices such as secondary batteries, electrochemical capacitors and fuel cells are known. The battery and capacitor devices directly store an input of electrical energy. It is known that fuel cells are inherently energy conversion devices which by electrochemical processes can transform the inherent energy of a potentially storable fuel into usable electricity.

Renewable energy sources such wind and solar are only intermittent generators of electric power that therefore need to be stored, preferably in a way that it can be efficiently conveyed to consumers. The most touted method is to use the electricity for generating hydrogen by an electrolysis of water and conveying the gas for storage at stationary or mobile sites where its energy content is recovered by combustion or preferably by using a fuel cell, for greater energy efficiency. The capital cost of establishing a hydrogen-transport infrastructure and the limitations in current vehicular hydrogen storage technologies have thus far resulted in only a very limited implementation of such a “Hydrogen Economy.”

An alternative energy storage approach, first proposed in the 1960's, is to use a “liquid organic hydrogen carrier” (LOHC) such as an organic liquid which is catalytically hydrogenated at the H₂-source site to ideally provide an easily storable and transportable fluid. For stationary or mobile applications, the LOHC can be catalytically de-hydrogenated and thus provide hydrogen ideally for powering a fuel cell. The H₂-depleted (“spent”) fuel is recycled to the hydrogen source site where it is reconstituted to its original composition by catalytic hydrogenation processes. Typical carrier liquids are the “molecule pairs”, cyclohexane/benzene, and decalin/naphthalene, in their hydrogenated and dehydrogenated forms, respectively. As recently expressed by Teichmann et al. in Energy Environ. Sci. 2011, 4, 2767, for a widespread societal acceptance, LOHC systems would have to meet specific technical performance standards, have low toxicity and have an acceptable environmental impact. The cited technical requirements are: a high hydrogen storage density; liquidity over a very wide temperature range; and the potential for heat-integration with a fuel cell by using the fuel cell's waste heat to supply the endotherm for hydrogen release. In Energy Environ. Sci. 2015, 8, 1035, Markiewitz et al. discuss criteria such as ecotoxicity and biodegradability as part of an environmental health and safety (EH&S) risk assessment of potential carriers.

Recently, based upon a consideration of the above criteria Bruechner et al., in ChemSusChem 2014, 7, 229 and Mueller et al., Ind. Eng. Chem. Res. 2015, 54, 7967 proposed the use of the industrially well-established synthetic heat transfer oils, Marlotherm LH (SASOL) and Marlotherm SH (SASOL)—and their perhydrogenated analogs as a new class of LOHC's. The compositions are further detailed in US Patent Publication No. 2015/0266731 as mixtures of isomers of benzyltoluene and dibenzyltoluene. Discussed is the use of these compositions for binding and releasing hydrogen for use of the gas by a customer. While attractive in several aspects: such as low vapor pressure; liquidity over a large temperature range; and existing EH&S data—for the commercial (non-perhydrogenated) oils, the perhydrogenated carriers require a substantial input of heat (namely, 71 kJ/mole H₂) and a relatively high temperature (namely, >270° C.) for hydrogen desorption in an appropriate catalytic reactor. This required energy input amounts to a loss of almost one-third of the lower heating value (LHV) of hydrogen in the absence of any heat integration. The 270° C. or higher temperatures preclude any heat-integration with existing commercial proton electrolyte membrane (PEM) and phosphoric acid fuel cells which operate at between 80° C. and 180° C., respectively. Particularly for vehicular systems where size and weight are at a premium, the design of a catalytic fuel-dehydrogenation reactor system that delivers hydrogen on demand from any LOHC is itself a major engineering challenge and very costly.

An alternative approach which circumvents the need for such a reactor has been to directly feed a perhydrogenated LOHC, e.g., cyclohexane to an electrochemical device like a fuel cell, where, with also an input of air or oxygen, the carrier is oxidatively dehydrogenated to benzene thereby providing electrical power, with water as a by-product. This is illustrated by the work of Kariya et al., in Phys. Chem. Chem. Phys. 2006, 8, 1724 and in Chem. Commun. 2003, 690 who reported on using a PEM fuel cell for a dehydrogenation of cyclohexane to benzene (C₆H₆) with the following half-cell reactions:

On anode, C₆H₁₂→C₆H₆+6H⁺+6e⁻

On cathode, 2H⁺+2e⁻+½O₂→H₂O

The overall reaction is, C₆H₁₂+3/2O₂→C₆H₆+3H₂O

Hydrogen gas is not released from the carrier consequently its energy content is directly converted into electricity. The electrical performance of a fuel cell (FC) is reported in terms of the open cell voltage (OCV) and power density. For this system, the OCV (0.91V) was close to the theoretical value. However, the highest observed power density (15 mW/cm² of electrode area), which determines the size and hence the cost of the device, was from one to two orders of magnitude less that of a present day commercial PEM cell that use hydrogen as the fuel. The methylcyclohexane/toluene LOHC pair was additionally investigated. Here the FC performed more poorly, (power density of ca. 3 mW/cm²), thereby attesting to the sensitivity of the device's performance to the molecular structure of the fuel. Additionally, Kariya et al. (as also disclosed in JP 2004-247080) demonstrated the electrochemical oxidative dehydrogenation of 2-propanol to acetone and water. For this system, the maximum power density was higher (78 mW/cm²) and significantly, it was also possible to under electrolysis conditions to reverse the reaction, albeit at very low efficiencies. While a pathway of directly using an H₂-loaded LOHC carrier in a fuel cell has clearly evident advantages, as in obviating the need for a dehydrogenation reactor, it presents very significant challenges in fuel cell design.

There have been a few other studies of so-called “direct” (not requiring a prior conversion of the fuel to H₂) cyclohexane to benzene PEM fuel cells with comparable (Kim et al., Catalysis Today 2009, 146, 9 or poorer (Ferrel et al., J. Electrochem. Soc. 2012, 159(4), B371 performance. In the latter publication, a PEM fuel cell functioning with perhydro N-ethylcarbazole—a well-studied LOHC (Pez et al., U.S. Pat. Nos. 7,101,530 and 7,351,395) as the input fuel exhibited a high OCV consistent with its relatively low hydrogen desorption temperature but afforded only a very low, minimal power output. Cheng et al. in US Publication Nos. 2014/0080026 and 2015/0105244 claim the use of perhydro N-ethylcarbazole and in general, an unsaturated heterocyclic aromatic molecule as the feed to a direct fuel cell energy storage and supply system, also an electrode material for such a cell in US 2015/0105244, but provide no actual fuel cell performance data for validating the concepts.

In U.S. Pat. No. 8,338,055, Soloveichik discloses an electrochemical energy conversion and storage system comprising a PEM or liquid fuel cell, the means to supply an organic liquid carrier of hydrogen (or LOHC) and an oxidant such as air or oxygen to the cell, as well as a vessel for receiving the hydrogen depleted liquid. Also discussed are carrier compositions which are organic compounds having at least two secondary hydroxyl groups which in the cell are electrochemically oxidized generally to ketone moieties. A large number of examples of such potential LOHC's is provided with estimated hydrogen storage capacities and computed dehydrogenation Gibbs Free Energy data (as kcal/mole of H₂), which is related to the fuel cell open circuit voltage, OCV. Notably, the presence of the at least two oxygen heteroatoms in the carrier molecule limits the gravimetric hydrogen capacity. Also, while some volumetric density data for the listed carriers in their hydrogenated forms is provided, there is no indication of their liquidity in both the hydrogen-rich and dehydrogenated states at operative conditions. But most importantly, there is no disclosure of experimental performance data (such as a measured OCV, and voltage and power density under load) for a fuel cell test device functioning with a claimed liquid organic hydrogen carrier.

Liu et al., in U.S. Pat. Nos. 8,871,393, and 9,012,097 disclose a regenerative fuel cell comprising an organic N- and/or O-heterocyclic compound fuel which is partially oxidized at the anode with a minimal production of carbon dioxide (CO₂) and carbon monoxide (CO). Partial oxidation is defined as “the transfer of at least one proton and one electron”. The spent fuel is regenerated either electrically or ‘in sit’, the latter using relatively costly and non-easily regenerable chemical reducing agents as exemplified by lithium aluminum hydride and other highly reactive organometallic reductants. Significantly, there is no teaching of the potential use of hydrogen (H₂) for effecting such a regeneration of the fuel.

Accordingly, considering these limitations there is a need in the art for materials, methods and apparatus for electrochemical energy conversion and storage using a hydrogen-regenerable, or electrically regenerable organic liquid fuel for the electrochemical device.

### SUMMARY OF THE INVENTION

In one aspect, the invention provides an electrochemical energy conversion system including an electrochemical energy conversion device, in fluid communication with a source of a hydrogen-regenerable or electrochemically regenerable liquid fuel and an oxidant, for receiving, catalyzing and electrochemically oxidizing at least a portion of the fuel to generate electricity, and a liquid which includes the at least partly oxidatively dehydrogenated fuel and water, wherein the liquid fuel is a composition comprising two or three alkyl-substituted cyclohexane molecules, that are variously linked via methylene, ethan-1,2-diyl, oxide, propan-1,3-diyl, propan-1,2-diyl or direct carbon to carbon linkages, or mixtures of such compositions.

In another aspect, the invention provides an electrochemical energy conversion system comprising an electrochemical energy conversion device, in fluid communication with a source of a hydrogen-regenerable or electrochemically regenerable liquid fuel, water and an oxidant, for receiving, catalyzing and electrochemically oxidizing at least a portion of the fuel to generate electricity, and a liquid which comprises the at least partly oxidatively dehydrogenated and selectively oxidized fuel, and water.

In one embodiment, the hydrogen-regenerable hydrocarbon liquid fuel is a liquid mixture comprising two or more compounds selected from a mix of different isomers of substantially aromatic ring hydrogenated benzyltoluene and a mix of different isomers of substantially ring-hydrogenated dibenzyltoluene.

In another embodiment, the electrochemically at least partly oxidatively dehydrogenated or spent liquid fuel includes a mixture of two or more compounds selected from a mix of different isomers of benzyltoluene and a mix of different isomers of dibenzyltoluene.

In another embodiment, the electrochemical partial oxidation of the fuel includes a conversion of an alkyl ring substituent group on a cycloalkane or on an aromatic molecule to an alcohol, aldehyde, ketone or carboxylic acid group.

In another aspect, the invention provides an electrochemical energy conversion system, wherein the electrochemical energy conversion device is a proton exchange membrane (PEM) fuel cell, including an anode, a cathode and a proton conducting membrane.

In one embodiment, the invention further includes a catalyst which is disposed within the electrochemical energy conversion device for assisting in the electrochemical oxidation of the liquid fuel.

In another embodiment, the catalyst is selected from a group consisting of palladium, platinum, iridium, rhodium, ruthenium, nickel and combinations thereof.

In another embodiment, the catalyst includes a metal coordination compound that is tethered to a carbon support, wherein the metal may be selected from a group consisting of palladium, platinum, iridium, rhodium, ruthenium, and nickel.

In one aspect, the invention provides a process for regenerating the spent liquid fuel by a catalytic hydrogenation process.

In one aspect, the invention provides a process for regenerating the spent liquid fuel by electrolysis.

In one embodiment, the proton conducting membrane is selected from the group consisting of sulfonated polymers, phosphonated polymers and inorganic-organic composite materials.

In one embodiment, the proton conducting membrane is selected from the group consisting of poly (2,5-benzyimidazole) (PBI) and combinations of poly(2,5-benzimidazole) and phosphoric acid or a perfluoroalkylsulfonic acid.

In one embodiment, a mesoporous carbon-tethered platinum metal complex catalyst is employed at the anode of the device.

In one aspect, the invention provides a direct fuel cell apparatus to convert chemical energy into electrical energy, the apparatus including (a) hydrogenated liquid fuel, the fuel including random isomeric mixtures of alkylated substantially hydrogenated aromatic rings; and (b) a membrane electrode assembly (MEA) comprising a membrane and electrodes, including a cathode and an anode, each including a catalyst; wherein the fuel is in fluid communication with the anode of the MEA, wherein the cathode is in communication with air or oxygen and wherein the apparatus operates at a temperature between about 80° C. to about 400° C. The fuel may optionally comprise water.

In one embodiment, the mixtures of alkylated substantially hydrogenated aromatic ring compounds include one or more compounds selected from the group consisting of methylcyclohexane, ethylcyclohexane, a mixture of isomers of perhydro (ie fully ring hydrogenated), benzyltoluene, and a mixture of isomers of perhydrodibenzyltoluene, and a mixture of isomers of perhydroxylene.

In another embodiment, the catalyst for the anode and the cathode is selected from the group consisting of palladium, platinum, iridium, rhodium, ruthenium, nickel and combinations thereof.

In another embodiment, the catalyst for the anode and the cathode includes a metal coordination compound that is tethered to a carbon support wherein the metal is selected from the group consisting of palladium, platinum, iridium, rhodium, ruthenium, and nickel.

In another embodiment, the membrane comprises a material selected from the group consisting of polymer functionalized with heteropoly acid, sulfonated polymer, phosphonated polymer, proton conducting ceramic, polybenzylimidazole (PBI) and combinations of polybenzylimidazole and phosphoric acid, and combinations of polybenzylimidazole and a long chain perfluorosulfonic acid.

In another embodiment, the apparatus operates at a temperature between about 100° C. to about 250° C.

In another embodiment, the invention provides a vehicle including the apparatus described above.

In another embodiment, the vehicle can be selected from the group consisting of a forklift, a car and a truck.

In another embodiment, the invention provides an energy conversion and storage site including the apparatus as described above.

In one embodiment, the energy conversion and storage site is selected from the group consisting of a wind farm, a solar farm, an electric power grid levelling system, and a seasonal energy storage system.

In one aspect, the invention provides a method of directly converting chemical energy into electrical energy, the method comprising the steps of: (a) providing a hydrogenated liquid fuel, the fuel including isomeric mixtures of alkylated substantially hydrogenated aromatic ring compounds; (b) providing a membrane electrode assembly (MEA), the electrode assembly including a cathode and an anode, each including a catalyst; and (c) contacting the fuel and the MEA, thereby converting chemical energy into electrical energy; wherein the fuel is in fluid communication with the anode of the MEA, wherein the cathode is in communication with air or oxygen and wherein the apparatus operates at a temperature between about 80° C. and about 400° C.

In one aspect, the invention provides a process for regenerating the at least partially oxidized liquid fuel as described above by electrolysis.

In one embodiment, the invention provides a process for regenerating the liquid fuel as described above with hydrogen by catalytic hydrogenation.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 is an illustration of the general structures of the liquid fuel, according to the present invention;

FIG. 2 is an illustration of the electrochemical energy conversion system, according to the present invention;

FIG. 3 is an illustration of the polarization curve for methylcyclohexane:

FIG. 4 is an illustration of the polarization curve for perhydrodibenzyltoluene; and

FIG. 5 is an illustration of the polarization curve for perhydrodibenzyltoluene from a fuel cell of improved performance.

### DETAILED DESCRIPTION OF THE INVENTION

In one aspect, the present invention speaks to the composition and utility of regenerable liquid-phase organic fuels that, when employed in an electrochemical energy conversion device such as a fuel cell, can provide a greatly augmented energy storage capacity vis-A-vis the liquid organic hydrogen carriers (LOHC's) of the current art. The fuels may be regenerated in situ by performing the electrochemical conversion process in reverse with an input of electrical energy. Alternatively, the “spent” fuels may be reconstituted via a catalytic hydrogenation process or in an electrochemical hydrogenation device with water as the source of hydrogen.

### Thermochemistry of Model Fuel Molecule Pairs

Liquid organic hydrogen carriers (LOHC), as described in the prior art, consist of “molecule pairs,” such as benzene/cyclohexane which in the presence of a catalyst can reversibly chemically bind hydrogen. The reversibility for hydrogen capture is fully quantified at a given temperature by the equilibrium constant (K), as illustrated for the reversible hydrogenation of benzene to cyclohexane reaction:

C₆H₆+3H₂↔C₆H₁₂ for which K=[C₆H₁₂]/[C₆H₆]×(pH₂)³ (atm⁻³)

where the terms in the square brackets are the component concentrations and the last term is the partial pressure of hydrogen. The equilibrium constant (K) is related to the changes in Gibbs Free Energy (ΔG), Enthalpy (ΔH) and Entropy (ΔS) and hence to temperature (T) by the familiar thermodynamics relationship:

−RT ln K=ΔG=ΔH−TΔS.

Thermodynamic properties as discussed herein were derived where possible from published experimental data (such as the National Institute of Standards and Technology (NIST) data base). Where these were not available, computed thermodynamics as in the T₁ data files of SPARTAN™ '16 (Wave Function Inc.) were used. Unless otherwise indicated, all the components of reported equilibria are assumed to be in the gas phase.

At 150° C., a reasonable temperature for catalytic hydrogenation K=1.97×10⁶ atm⁻³ (all components in the gas phase), H₂ addition is highly favorable (ΔG=−51 kJ/mole). However, it is necessary to heat the system to 280° C. (where K→1 atm⁻³ as ΔG→0) or higher for a practical dehydrogenation of cyclohexane.

However, in an electrochemical conversion device, such as the PEM fuel cell described by Kariya el al., the cyclohexane undergoes overall, an oxidative dehydrogenation reaction with now oxygen or air as a co-reactant, thereby providing electric power, with benzene (C₆H₆) and water as-by-products:

C₆H₁₂+3/2O₂→C₆H₆+3H₂O

which, as essentially a combustion reaction, is thermodynamically always highly favored, with practically no temperature limitations. For instance, for this reaction: ΔG=−617 kJ/mole, K=5.8×10⁷⁶ at 150° C. and −653 kJ/mole; K=3.9×10⁵⁹ at 300° C. (All components are assumed to be in the gas phase). It is noted that this ΔG is the available energy that, ideally, is recoverable as electric power by an electrochemical conversion device, at the specified temperature. The available energy density of the fuel/spent fuel pair is defined by ΔG⁰ (ΔG at standard conditions, of. 25° C., 1 atm) and expressed as kilojoule (kJ) per unit mass or volume of the carrier fuel, for a specified fuel pair. For the above oxidative dehydrogenation of cyclohexane reaction, ΔG⁰=−588 kJ/mole and the energy density is estimated as 6.99 kJ/gram of cyclohexane, for the cyclohexane/benzene molecule pair.

### Electrochemical Oxidative Dehydrogenation

As a first embodiment of this invention, it is recognized that operating in such an electrochemical oxidative dehydrogenation mode—with now minimal thermodynamic constraints, can broaden the range and offer a wider choice of potential LOHC molecule pairs. This is illustrated by reference to ethylcyclohexane (C₆H₁₁C₂H₅) as an LOHC fuel. A catalytic dehydrogenation of the molecule may be expected to first yield ethylbenzene (C₆H₅C₂H₅ (6H's/8C atoms)), then styrene (C₆H₅C₂H₃ (8H's/8C atoms)) and then phenylacetylene (C₆H₅CCH (10H's/8 C atoms)), the latter potentially providing an unprecedented 9.5 wt % equivalent hydrogen storage capacity, versus 7.17 wt % for the cyclohexane/benzene pair. However, only the first conversion of ethylcyclohexane to ethylbenzene, for which K→1 and ΔG→0 at about 280° C. would be of value for hydrogen storage. The corresponding dehydrogenation temperatures required for a further loss of H₂ to styrene and phenylbenzene and phenylacetylene at 690° C. and 1250° C. are much too high and would lead to a skeletal cracking of the molecules.

On the other hand, in an electrochemical oxidative dehydrogenation process, with now water as a by-product, all three conversions from ethylcyclohexane→ethylbenzene→styrene→phenylacetylene are thermodynamically feasible at 150° C., which is a reasonable temperature for an operational fuel cell. The Gibbs free energy changes for this illustrative example are respectively, −624, −154 and −89 kJ/mole. (It is noteworthy that the contribution to this ΔG diminishes as the dehydrogenation of the carrier molecule becomes energetically more demanding). For the total reaction: ethylcyclohexane to phenylacetylene and water as the by-product, overall:

C₆H₁₁C₂H₅+2.5O₂→C₆H₅CCH+5H₂O; ΔG⁰=−820 kJ/mole

which corresponds to an energy density of 7.35 kJ/gram of ethylcyclohexane for this ethylcyclohexane/phenylacetylene molecule pair. As compared to the 5.39 kJ/gram ethylcyclohexane for the ethylcyclohexane/ethylbenzene system and 6.99 kJ/gram of cyclohexane for the cyclohexane/benzene fuel pair, the last representing the highest gravimetric energy density (C:H=1) for a potentially practical organic liquid hydrogen carrier (i.e., one that can deliver H₂ at less than about 280° C.).

In general terms, such an oxidative electrochemical dehydrogenation process may be described by the following equation:

[S]Hₐ+x/2O₂→[S]Hₐ₋₂ₓ+xH₂O (1) (Reaction 1)

where [S]Hₐ represents a hydrocarbon molecule that contains in its structure ‘a’ hydrogen atoms that can potentially undergo this transformation, with 2x≤a. From a purely thermodynamic viewpoint, Reaction 1 may be thought of as the combination of a usually endothermic, equilibrium-limited dehydrogenation of [S]Hₐ to [S]Hₐ₋₂ₓ and xH₂ and an exothermic combustion of the hydrogen to water. It is not limited to, as is implied in the prior art (e.g., Soloveichik, U.S. Pat. No. 8,338,055) to practically H₂-reversible systems, but only to an overall favorable Gibbs Free Energy change, i.e., −ΔG>0. In this sense, gravimetric or volumetric ‘hydrogen storage capacity’ or ‘equivalent hydrogen storage capacity’ (as employed for example by Liu et al in U.S. Pat. No. 8,871,693) are not meaningful measures of stored energy without also specifying the required energy for releasing the hydrogen at the conditions of its use. In other words, a nominal high hydrogen capacity in an LOHC does not necessarily imply that the fluid has a high energy density. As illustrated above, the energy storage density of the organic liquid fuels of the present invention is fully defined by ΔG°/unit mass or unit volume of the molecule pair or fuel pair.

The contained energy in the fuel could in principle mostly be recovered as heat by performing Reaction 1 in the presence of a catalyst that provides the required reaction selectivity at sufficiently high temperatures. As an embodiment of the present invention however, the same overall transformation is conducted in an electrochemical energy conversion device, such as a proton electrolyte membrane (PEM) fuel cell with electricity as the output—as well as some waste heat. The device comprises anode and cathode compartments which are separated by a proton conducting electrolyte. The [S]Hₐ fuel entering the anode compartment is oxidized (loses ‘2x’ electrons) providing protons to the electrolyte and the spent fuel by-product:

[S]Hₐ−2xe⁻↔2xH⁺+[S]Hₐ₋₂ₓ (1a).

At the cathode, oxygen and protons are reduced to water:

x/₂O₂+2xe⁻+2xH⁺↔xH₂O. (1b).

A flow of current in an external load completes the circuit, to the overall chemical transformation, as formulated above (Reaction 1). The Gibbs Free Energy change (ΔG) for Reaction 1 is the maximum useful energy as electrical output that can be derived from the cell and as such it is a measure of the potentially usable energy storage capacity of the [S]Hₐ/[S]Hₐ₋₂ₓ molecule pair. The cell open circuit voltage (OCV) (E), as measured experimentally in the absence of a load in the external circuit, is related to the Free Energy change (ΔG) by the Equation:

ΔG=−nFE, where n is the number of electrons transferred from anode to cathode and F is Faraday's constant.

### Electrochemical Oxidative Dehydrogenation and Selective Partial Oxidation

A second embodiment of the present invention that can lead to a significantly higher energy storage capacity includes both an electrochemical oxidative dehydrogenation and an electrochemical selective partial oxidation of the fuel, the latter now comprising an incorporation of oxygen. Water is a by-product for at least some of the reactions. As an illustration of this concept, consider the potential oxidative reactions of methylcyclohexane (C₆H₁₁CH₃):
1. An electrochemical oxidative dehydrogenation of the ring hydrogens to toluene: C₆H₁₁CH₃+1.5O₂→C₆H₅CH₃+3H₂O; ΔG⁰ (25C)=−591 kJ/mole.
2. An electrochemical partial oxidation of the side chain to yield benzyl alcohol: C₆H₅CH₃+0.5O₂→C₆H₅CH₂OH; ΔG⁰ (25C)=−133 kJ/mole.
3. An electrochemical further partial oxidation of the side chain affording benzaldehyde:
4. C₆H₅CH₂OH+0.5O₂→C₆H₅CHO+H₂O; ΔG⁰ (25C)=−195 kJ/mole.
5. And a still deeper partial oxidation of the side chain to give benzoic acid: C₆H₅CHO+O₂→C₆H₅COOH; ΔG⁰ (25C)=−233 kJ/mole.
6. Overall: C₆H₁₁CH₃+3O₂→C₆H₅COOH+4H₂O; ΔG⁰ (25C)=−1152 kJ/mole, leading to an energy density of 1152/98.19=11.65 kJ/gram of methylcyclohexane for the cyclohexane/benzoic acid pair.

The partial oxidation (with now incorporation of an oxygen atom n) reaction steps provide an up to 95% increase in the energy density of the fuel: From −591 kJ/mole for Step 1 alone to −1152 kJ/mole for the sum of Steps 1-5. Even a milder oxidation to only benzaldehyde as the product (Steps 1, 2 and 3) would result in an energy density of 9.36 kJ/gram of methylcyclohexane for the methylcyclohexane/benzaldehyde fuel pair. Conceivably, the electrochemical transformation of the fuel could also occur with first a partial oxidation of the side chain of methylcyclohexane and then a dehydrogenation of the ring. While the energetics for these individual reactions would be a little different than for Steps 1. and 2. above, the total energy change to benzaldehyde and benzoic acid will be unchanged. The electrochemical oxidation of toluene, which has been studied by several investigators can be made selective by the choice of the catalyst and conditions, for example to yield benzaldehyde as the major product (Balaji, Phys. Chem. Chem. Phys. (2015). In JP Patent Application 04-099188, there is disclosed a method for the manufacture of benzaldehyde and benzoic acid by electrochemical oxidation of toluene using a fuel cell.

As another example of this electrochemical partial oxidation approach for an enhanced energy storage, consider an oxidative dehydrogenation of the ring hydrogens of ethylcyclohexane to ethylbenzene, then followed by a sequential partial oxidation of the side chain to phenylmethylcarbinol and phenylmethylketone:
1. An oxidative dehydrogenation of the ring hydrogens to ethylbenzene: C₆H₁₁CH₂CH₃+1.5O₂→C₆H₅CH₂CH₃+3H₂O; ΔG⁰=−594 kJ/mole
2. Partial oxidation of ethylbenzene to phenylmethylcarbinol: C₆H₅CH₂CH₃+½O₂→C₆H₅CH(OH)CH₃; ΔG⁰=−143 kJ/mole
3. Partial oxidation of phenylmethylcarbinol to acetophenone: C₆H₅CH(OH)CH₃+½O₂→C₆H₅C(O)CH₃+H₂O; ΔG⁰=−213 kJ/mole
Overall: C₆H₁₁CH₂CH₃+2.5O₂→C₆H₅C(O)CH₃+4H₂O; ΔG⁰=−952 kJ/mole, leading to an available energy density of 952 kJ/mole or 8.48 kJ/gram or 2441 Wh/Kg of ethylbenzene for the ethylbenzene/acetophenone fuel pair.

As an added illustration of the concept, consider an electrochemical oxidative dehydrogenation of dicyclohexylmethane to diphenyl methane, then a partial oxidation to diphenylcarbinol and finally to benzophenone:
1. (C₆H₁₁)₂CH₂+3O₂→(C₆H₅)₂CH₂+6H₂O; ΔG⁰=−1208 kJ/mole
2. (C₆H₅)₂CH₂+½ O₂→(C₆H₅)₂CHOH; ΔG⁰=−126 kJ/mole
3. (C₆H₅)₂CHOH+½ O₂→(C₆H₅)₂CO+H₂O; ΔG⁰=−217 kJ/mole
Overall: (C₆H₁₁)₂CH₂+4O₂→(C₆H₅)₂CO+7H₂O; ΔG⁰=−1551 kJ/mole
   leading to an energy density of 1551 kJ/mole or 8.60 kJ/gram dicyclohexylmethane for the dicyclohexylmethane/acetophenone fuel pair. It is evident from these examples that a partial oxidation of a substituent on the cyclohexane ring can greatly augment the potentially available energy of the input fuel to the electrochemical device, beyond that of an oxidative dehydrogenation of the cyclohexane ring. A selective electrolytic side-chain oxidation of alkylbenzenes, including diphenylmethane to the corresponding ketones, has been reported: (Yoshida et al., J. Org. Chem. 1984, 49, 3419).

It is desirable that the electrochemical partial oxidation reactions proceed selectively to reaction products that can be catalytically hydrogenated or electrochemically reduced, either electrolytically or with hydrogen, preferably as a one-step process (vide infra). Thus, the electrochemical partial oxidation reaction should be sufficiently selective in order to minimize or preclude a practically irreversible degradation of the molecule as by carbon-carbon bond breaking reactions, which may also lead to the formation of unwanted highly volatile by-products, such as carbon monoxide (CO) and carbon dioxide (CO₂) that would be difficult to recover and not a practical starting point for a regeneration of the fuel.

A partial oxidation reaction in the electrochemical conversion device with a proton conducting electrolyte such as a PEM fuel cell, always requires an addition of water to the anode compartment along with the fuel, as illustrated in general terms by the following half-cell reactions:

At Anode: [S]Hₐ+yH₂O−4ye⁻↔[S]H_{a-2y}O_{y}+4yH⁺ (2a)

At Cathode: yO₂+4yH⁺+4ye⁻↔2yH₂O (2b)

Net Reaction: [S]Hₐ+yO₂→[S]H_{a-2y}O_{y}+yH₂O (2),

where 2y≤a.

There is also the possibility that in at least one step of an electrochemical partial oxidation reaction sequence oxygen is incorporated in the fuel without a net production of water. This is the case for example in Steps 2 and 4 of the above discussed electrochemical partial oxidation of methylcyclohexane, where benzyl alcohol and benzoic acid are reaction products: In general, where a hydroxyl (—OH) group containing moiety, such as an alcohol, carboxylic acid or a phenol are the resultant reaction products. The half-cell reactions for the hydrocarbon reactant fuel, [S]Hₐ may then be illustrated as follows:

At Anode: [S]Hₐ+yH₂O−2ye⁻↔[S]H_{a-y}(OH)_{y}+2yH⁺ (2a′)

At Cathode: 0.5yO₂+2yH⁺+2ye⁻↔yH₂O (2b′)

Net Reaction: [S]Hₐ+0.5yO₂→[S]H_{a-y}(OH)_{y} (2′),

Similar half-cell reactions may be written for when the initial fuel has undergone some incorporation of oxygen, as to an aldehyde. As the source of oxygen, water will always be needed at the cathode but ideally, there will be no net consumption by the device.

In most cases (as for the last three examples), the fuel is expected to undergo both electrochemical oxidative dehydrogenation and partial oxidation processes, the latter with addition of oxygen to the molecule of fuel. In which case, the overall reaction is described by Equation 3, as a combination of reactions in Equations 1 and 2:

Net Reaction: 2[S]Hₐ+½xO₂+yO₂→[S]Hₐ₋₂ₓ+[S]H_{a-2y}O_{y}+(x+y) H₂O (3)

where 2x≤a and 2y≤a. (The formulation of an —OH group containing product (as in Equation 2′) is left out for simplicity).

### Regeneration and Recycling of the “Spent” Liquid Fuel

A third embodiment of the invention relates to a method for the recycling and regeneration of the at least partly electrochemically dehydrogenated and the at least partially electrochemically selectively oxidized organic liquid fuel. The reactions taking place at the electrodes of the electrochemical conversion device, which result in an electrical current or electron flow from the anode to the cathode can be reversed by applying an external potential (electrolysis conditions), such that current flows in the opposite direction. As cited in the Background section Kariya et al, also Liu et al used a PEM fuel cell for an electrochemical oxidative dehydrogenation of isopropanol to acetone and water and then partially reversed the reaction by electrolysis. For electrochemical cells electrodes are defined as ‘anode’ and ‘cathode” by the direction of electron flow, always from the anode—where oxidation occurs, to the cathode—where reduction takes place. In this electrolysis process, water in the anode compartment is electrochemically oxidized to protons with oxygen as a by-product, i.e., the reverse of half-cell reaction 1b, above. The protons pass through the membrane to the cathode side where the ‘spent’ fuel is electrochemically regenerated—the reverse of reaction 1a. In the electrolytic regeneration of an oxygen-containing fuel (the reverse of reaction 2a), water will be a by-product. In the most general case, for an electrochemically dehydrogenated and electrochemically partially oxidized ‘spent’ fuel the overall transformation involving water electrolysis, and an electrochemical hydrogenation and electrochemical reduction of the ‘spent’ fuel is described by Reaction 4 (the reverse of Equation 3).

[S]Hₐ₋₂ₓ+[S]H_{a-2y}O_{y}+(x+y)H₂O→[S]Hₐ+½xO₂+yO₂ (4)

Such an in-situ regeneration of the liquid fuel by the same electrochemical conversion device could, for example, be employed for electrically refueling a vehicle or as part of a home unit or a larger scale solar/wind renewable energy storage system.

In a further embodiment of the invention the ‘spent’ liquid fuel is regenerated by a stand-alone electrochemical device, an electrolysis reactor that operates with an input of electric power and water. The operating principle of the device is the same as that of the fuel cell operating in a regeneration mode: Spent fuel is reduced at the cathode with water electrolysis taking place at the anode, the overall reaction as defined by Equation 4. There are several recent reports of a remarkably electrically efficient electrochemical reduction (electrohydrogenation) of toluene to methylcyclohexane, operating along with water electrolysis in the same cell: e.g., Mitsushima et al, Electrocatalysis 7(2), 127 (2016); Matsuoka et al, J. of Power Sources 343, 156 (2017). These reports well support the expected feasibility of electrochemically converting the aromatic structures in the spent fuel to saturated cyclohexane moieties. Of the literature on an electrochemical hydrogenation of carbonyl, ═CO, and other polar functional groups the most relevant is a report of an electrohydrogenation of acetophenone, C₆H₅—C(O)CH₃ to 1-phenylethanol, C₆H₅—CH(OH)CH₃ in a PEM cell (Saez et al Electrochimica Acta 91, 69 (2013). However, in this case hydrogen, H₂ is fed to the anode. This system would have to be modified and elaborated on—as by employing different catalytic electrodes for using water (and electricity) instead of hydrogen as the anode's fuel.

The electrohydrogenation device for this embodiment of the invention could be part of a local ‘regenerable liquid fuel mini-grid’ that functions as a central fuel regenerating facility for several electrochemical energy conversion units. Alternatively, it may be a remote larger facility that's preferably integrated with a renewable electrical energy source. Depending on the distances involved the regenerable liquid fuel could be transported-both ways by truck, by existing fuel infrastructure or new dedicated pipelines. An advantage of this regeneration approach vs. the in-situ method is that it would allow the respective electrochemical devices to be separately optimized for maximum performance.

In another embodiment of the present invention, it is envisioned that the spent fuel is collected at the site of use or distribution, transported and “recycled” to a chemical processing site where it is regenerated preferably in a single process step via catalytic hydrogenation. As for the electrolytic regeneration method, the process may be run locally, at a pilot-plant scale providing the regenerated fuel for a limited community of users, possibly with electricity from the electric grid. But preferably conducted at more distant locations, close to a (preferably ‘green’) electrical energy source, in large-scale plants offering the economy of scale. There is considerable research knowledge and an extensive industrial art on the catalytic hydrogenation of organic compounds. Specifically, Nishimura (in Handbook of Heterogeneous Catalytic Hydrogenation for Organic Synthesis” Wiley Publ. 2001) describes methods and recommended catalysts for a direct (one-step) selective hydrogenation of molecules of “spent” fuel of this invention comprising benzene, toluene and aromatic molecules to which aldehyde, ketone, carboxylic acid and other functional groups are attached. (See Nakamura Ch. 11, 414-425; Ch. 5 170-178; 190-193; Ch 10, 387-392). It is noted that in an industrial scale process, a “one-step” catalytic chemical conversion may actually involve several sequential unit operations.

The reactant hydrogen, is now the energy source that is imparted to the fuel. A general reaction stoichiometry for the hydrogenation of a partly dehydrogenated and partly oxidized organic liquid fuel is as follows:

[S]H_{a-2x-2y}O_{y}+(x+2y)H₂→[S]Hₐ+yH₂O (5)

It is noted that in most cases, this hydrogenation reaction is spontaneous and exothermic (i.e., ΔG⁰˜0 or <0 and ΔH⁰<0), the latter corresponding to a loss in the inherent energy of hydrogen (the thermodynamic cost of ‘containing’ the gas), which could in principle be recovered in part, by combined cycle processes as in making use of this reaction's exotherm for space heating or cooling.

While most hydrogen is now manufactured in large scale processes as steam-methane reforming, there are developing technologies for its efficient production from renewable resources, by water electrolysis using wind or solar generated electric power. The environmental benefits of the electrochemical energy conversion and storage concepts of this invention would come from a regeneration of the liquid fuel from such ‘green’ energy sources.

### Liquid Fuel Compositions

The above illustrations indicate that a fuel for an electrochemical energy conversion device (ECD) would comprise (a) a perhydrogenated aromatic molecule/aromatic molecule pair and preferably, (b) for a potentially higher energy density, also ring-attached reduced/oxidized functional groups pairs at varying levels of introduced or initially contained oxygen. However, a practical fuel would have to meet several other physical property requirements including a low solubility in water, a minimal vapor pressure and a good fluidity over a wide range of operating conditions—including to sub-ambient temperatures.

Heat transfer fluids—also known as thermal fluids which are widely used in the petroleum, gas, solar energy and chemical processing industries have some of the above desirable physical properties of a liquid fuel. In composition, the fluids range from glycols—usually employed for cooling applications to fractionated hydrocarbon oils and synthetic organic liquids as used in more demanding higher temperature applications. Their liquidity or liquid range over a wide range of temperatures is most often realized by employing complex mixtures of related compositions as in the ‘alkylated aromatics’ class of synthetic heat-transfer fluids, e.g., DOWTHERM™ T which consists of benzene derivatized with C₁₄ to C₃₀ long alkyl hydrocarbon chains. There may be additional components as for the DOWTHERM™ Q fluid also from the Dow Chemical Co., which consists of a mixture of alkylated aromatics and diphenyl ethane with a liquid range of from −35° C. to 330° C. (Lang et al., Hydrocarbon Engineering, February 2008, 95), also biphenyl (C₁₂H₁₆) and diphenyl ether (C₁₂H₁₀O) components as in DOWTHERM™ A. (Dow Chemicals Inc. heat transfer fluids product brochure. From dow.com/heattrans/products/synthetic/dowtherm.htm). Even fused aromatics, such as 1-phenylnaphthalene, which surprisingly is a liquid at room temperature, have been studied as heat transfer fluids (McFarlane et al., Separation Science and Technology 2010, 45, 1908). Industrially employed and proposed synthetic heat transfer fluids provide a useful background knowledge base for the design of electrochemical energy conversion fuels. Also, some of the known if not at present commercial heat-transfer fluids may possess or could be chemically functionalized to yield the desired characteristics of a fuel for an electrochemical energy conversion system of this invention.

As cited earlier, Bruechner, Mueller and U.S. Publication No. 2015/0266731 propose the use of liquids composed of a mixture of isomers of benzyltoluene or dibenzyltoluene (industrial heat transfer fluids from SASOL) in catalytic processes to bind and/or release hydrogen. The fluids are in this way employed as traditional LOHC compositions for storing and releasing hydrogen gas to a consumer. However, there is no teaching of a direct use of the compositions (as the perhydrogenated molecules) as a direct fuel to an electrochemical energy conversion device, for instance to a fuel cell.

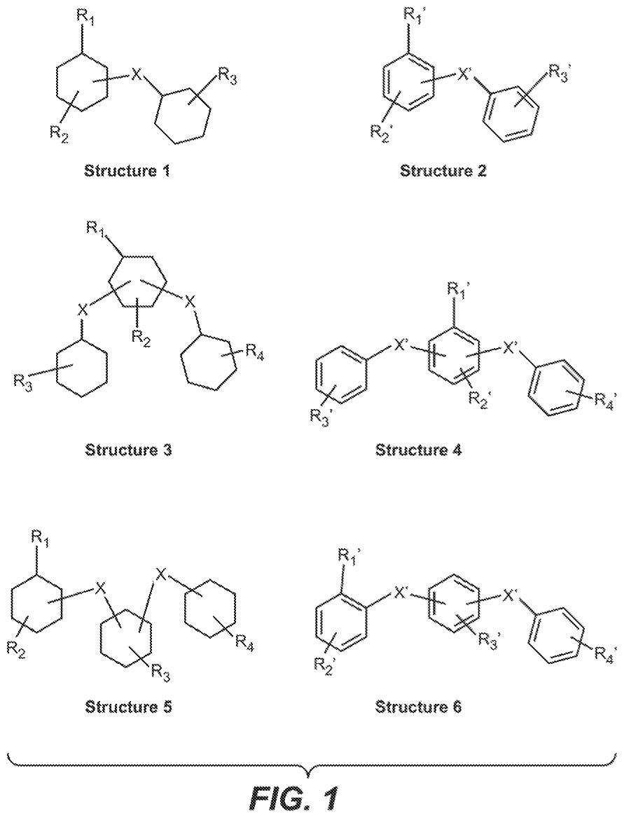

In consideration of meeting the electrochemical cell's fuel requirements: (a) and (b) above as well as a desirably low vapor pressure and a wide liquidity range for the device, the following general compositions, molecular structures for the reduced, ring-perhydrogenated molecule/ring-dehydrogenated or partially oxidized ‘molecule pairs’ are proposed as the fuels for the electrochemical devices of this invention. These compositions are now defined with reference to FIG. 1.

The fuel may include two or three variously linked and variously-substituted six-membered rings which designate substituted cyclohexane molecules (as cyclohexyl (C₆H₁₁-radicals) and cyclohexylene (—C₆H₁₀— bivalent radicals)): Structures 1, 3 and 5, and the corresponding linked and substituted benzene molecules: Structures 2, 4 and 6. These represent respectively, the reduced energy-rich and the electrochemically dehydrogenated or selectively oxidized energy-depleted state of the fuel. It is noted that when the fuel comprises three six-membered rings, these may be arranged in a “branched” (Structures 1 and 2) or in a “linear” (Structures 3-6) arrangement.

The groups, R₁ to R₄, which substitute for hydrogens in Structures 1, 3 and 5 may variously be: alkyl groups of a chain of not more than six carbon atoms but preferably as only one to three carbon atoms, i.e., methyl, ethyl, propyl and isopropyl groups from zero to four R₁ to R₄ substituents per ring. However, for Structures 1 and 2, there must be at least one substituent, R₁ and R₁′, respectively. The X linkage groups may variously be methylene (—CH₂—), ethan-1,2-diyl (˜CH₂CH₂-), propan-1,3-diyl, propan-1,2-diyl, or oxide, —O—, or no linking group with in this case the ring structures being directly linked with carbon-carbon bonds. In each of the structures as shown in FIG. 1, at least one bond of the X linkage is directed at the center of a six-membered ring signifying that it may be connected to any one of the remaining positions of the ring. When the —X-group links two six-membered rings by its attachment to specific carbon atoms of each chain, this defines a particular structure of the molecule. Other structures (isomers) are possible by the —X-group linking a different pair of carbon atoms of the rings. Each such configuration structurally defines one of the possible positional isomers of the molecule. The fuel molecule may consist of one, two or a mixture of positional isomers. The inherent potential ‘randomness’ from a mixture of positional isomers may be of value for inhibiting crystallization at low temperatures, and thus offer a broader liquid range of the fuel.

When the electrochemical conversion of the fuel results in only a partial or a complete electrochemical oxidative dehydrogenation of the cyclohexane rings, the substituent, R-groups and the —X-linkage groups remain unchanged (R₁-R₄≡R₁′-R₄′ and X≡X′). However, if the process additionally includes an electrochemical partial oxidation of the ring substituents and linkage groups then R₁′-R₄′ and —X—′ (in Structures 2, 4 and 6) may now be, to a varying degree, in a partially oxidized form as was illustrated above with estimated thermochemical data for methyl, ethyl and methylol substituents on cyclohexane and benzene moieties. In general, but in not exclusive terms, possible partial oxidation sequences for the R₁-R₄ groups and the —X-linkages are:

Methyl→methyol (—CH₂OH), →methanal (—CHO)→carboxylic acid (—COOH)

Ethyl→ethyol (—CH₂CH₂OH) or 1-methyl-methyol (—CH₂(OH)CH₃)→ethanal (—CH₂CHO) or 1 methyl methanol (—C(OH)CH₃)→carboxylic acid —CH₂COOH.

The X linkages (other than oxide) may also be electrochemically partially oxidized:

Methylene (—CH₂—)→a ketone (—C(O)—); and ethan-1,2-diyl (—CH₂CH₂—)→a ketone (—C(O)CH₂—) or a 1,2-diketone (—C(O)C(O))— group.

The fuel may also include methyl cyclohexane, C₆H₁₁CH₃, ethylcyclohexane, C₆H₁₁CH₂CH₃ and a mixture of isomers of perhydrogenated xylene, C₆H₁₀(CH₃)₂. The methyl cyclohexane would be electrochemically oxidatively dehydrogenated to toluene, C₆H₅CH₃ and potentially in addition undergo an anodic partial oxidation to benzyl alcohol, C₆H₅CH₂OH, benzaldehyde, C₆H₅CHO and benzoic acid, C₆H₅COOH. Similarly, the xylenes would undergo an anodic dehydrogenation of the ring and potentially also an electrochemical selective oxidation of one or both of the methyl substituents to the corresponding alcohols, aldehydes and carboxylic acids. Potential electrochemical ring dehydrogenation and electrochemical partial oxidation reactions of ethylcyclohexane are detailed above.

### Examples 1-4 (Computationally-Based)

### Example 1

Electrochemical oxidative dehydrogenation of a mixture of perhydrogenated benzyltoluene isomers to a mixture of benzyltoluene isomers (for the estimation of ΔS, computationally modelled as 3-benzyltoluene).

Referring to compositions and structures in FIG. 1:

Composition of Structure 1 with R₁═CH₃ as the only ring substituent and X═—CH₂—, +3O₂→Composition of Structure 2 with R₁′═CH₃ as the only ring substituent and X′═—CH₂—, +6 H₂O: ΔG⁰=−1208 kJ/mole, *. Open circuit voltage (OCV)=1.259 V (n=12) Energy Density=6.215 kJ/gram or 1726 Wh/kg for the perhydrogenated benzyltoluene isomers/mixture of benzyltoluene isomers molecule pair.

*Estimated from Δ_{f}⁰ (gas) experimental data of perhydrobenzyltoluene, labeled as 12H MLH in Mueller et al., Ind. Eng. Chem. Res. 2015, 54, 79, and an entropy, ΔS (gas) taken from the SSPD data base, calculated at the EFD2/6-31G* level, from the SPARTAN™ 2016 Quantum Chem. Package (Wavefunction Inc.). Using the Δ_{f}⁰ (liquid) data for 12H-MLH from Mueller et al with the same (gas phase) entropy values results in only a very small change in ΔG⁰ to −1214 kJ/mole. However, when water (liquid) is now the product, ΔG⁰=−1265 kJ/mole.

### Example 2

A mixture of the same perhydrogenated benzyltoluene isomers as in Example 1 is converted to a mixture of benzyltoluene isomers and, in addition, the methylene group is selectively oxidized to a carbonyl group:

Structure 1 with R₁=methyl (CH₃) and X=methylene (—CH₂—), +4O₂→Structure 2 where now X′ is a bridging carbonyl, C(O)+7H₂O; ΔG⁰=−1564 kJ/mole; OCV=1.013 V (n=16)
Energy density=8.047 kJ/gram or 2235 Wh/kg, for the perhydrogenated benzyltoluene isomers/mixture of benzoyltoluene isomers molecule pair.
The oxidation of the bridging methylene to a bridging carbonyl results in a 29% increase in energy density, or maximum energy storage capacity of the fuel.

### Example 3

As for Example 2, with in addition, a selective electrochemical oxidation of the methyl group to an aryl carboxylic acid group (—COOH):

Structure 1 with R₁=methyl (CH₃), X═—CH₂—+5.5 O₂→Structure 2 where X′═C(O) and R₁′═COOH; ΔG⁰=−2122 kJ/mole, OCV=1.0 V (n=22) Energy density=10.92 kJ/gram or 3030 Wh/kg
The oxidation of the methyl group to a carboxylic acid group provides an additional 35% increase in energy density. The two oxidation steps result in a total 75% increase in the energy storage capacity of the original fuel. A selective oxidation of added functional groups (R₂ to R₄) may be expected to lead to further enhancements in electrochemical energy storage capacity of the fuel.

### Example 4

An electrochemical oxidative dehydrogenation of a perhydrogenated benzyl-benzylalcohol mixture of isomers with, in addition, an electrochemical oxidation of the benzyl alcohol group to a carboxylic acid group and of the bridging methylene to a carbonyl:

Structure 1 with R₁═CH₂OH and X═—CH₂—, +5O₂→Structure 2 with R₁′═COOH and X′═C(O), +8H₂O ΔG⁰=−1989 kJ, OCV=1.031 V Energy Density=9.45 kJ/gram or 2626 Wh/kg
This example is provided as an illustration of another functional group substituent, —CH₂OH instead of —CH₃ in Structure 1. As expected, the energy storage density for the Structure 1 (R₁═CH₂OH and X═—CH₂—)/Structure 2 (R₁′ ═COOH and X′═C(O)) molecule pair) is a little smaller but there may be a potential advantage in that the methylol group in Structure 1 is expected to be more easily electrochemically oxidizable than a methyl.
Significance of Data from Examples 1-4 for Vehicular Energy Storage

The above energy density data for the representative fuels of the present invention is placed in a useful, practical perspective by the following analysis: The energy density of the fuel pair of Example 1, ΔG⁰=6.215 kJ/gram or 5.42 MJ/Liter, or 1.51 kWh/L (density of perhydrogenated benzyltoluene isomers mixture from Mueller ref.). The last target would favorably compare with the DOE's 1.3 kWh/L system volumetric hydrogen storage target for 2020. (DOE Technical Targets for onboard hydrogen storage for light duty vehicles, energy.gov/eere/fuelcells). Alternatively, the above may be compared to the known energy density of gasoline or diesel but would require making assumptions of the fuel to wheels efficiency of these hydrocarbons, and the efficiency in use of the regenerable fuel of the present invention, for a model common vehicle.

A more meaningful approach is by relating to the performance of (the few available) present day commercial hydrogen powered fuel cell vehicles (FCVs): A 2016 Hyundai Tucson small SUV and a 2016 Toyota Mirai with a Fuel Economy of 50 miles/Kg H₂ and 66 Miles/Kg H₂, respectively, for a driving range of 265 miles and 312 miles, respectively. (Data from fueleconomy.gov/feg/fcv_sbs.shtml site). A ‘representative’ (probably Compact size) FCV might require 4-5 Kg of hydrogen, currently as a compressed gas for a three-hundred-mile journey. The total stored usable energy, calculated as ΔG⁰ for the combustion of 4.5 kg of H₂ to water vapor at 80° C. (a typical FC operating temperature) is 504 MJ. A vehicle, with an electrochemical energy conversion device of the present invention replacing the fuel cell, would require 504 MJ/5.42 MJL⁻¹=93 Liters or 24.5 US gallons of the liquid fuel of Example 1. For an energy density of 10.91 kJ/gram or 9.52 MJ/Liter, as in Example 3 only 53 Liters or 14 gallons of the liquid fuel would be needed for the same driving range. Even higher energy storage capacities should be possible with a “deeper” and selective electrochemical partial oxidation of the liquid fuel.

### Examples 5-7 (Experimental Fuel Cell Performance Data)

### Apparatus and Experimental Procedures

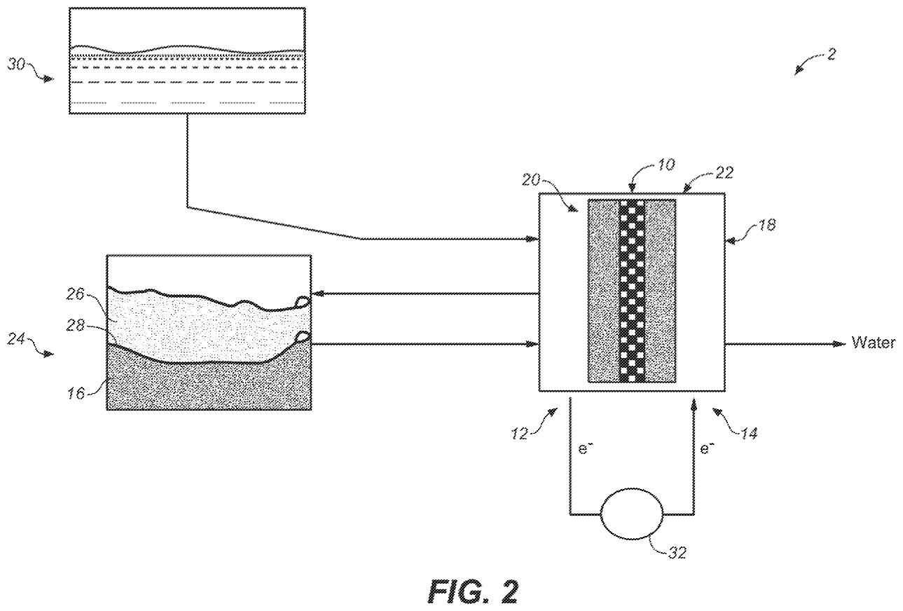

Membrane electrode assemblies (MEA's)—(FIG. 2) were tested using Scribner test stands and fuel cell technologies hardware. Each MEA 2 used in this study had an active area of 25 cm². Both the anode 12 and the cathode 14 contained 1.56 mg-Pt/cm² that was coated on hydrophobic gas diffusion layers. The composite membranes 10 were composed of polybenzimidazole (PBI)/20% 12-silicotungstic acid (HSiW)/phosphoric acid (PA). The MEA was hot-pressed at 1.5 tons at 100′C for 3 minutes before assembly and testing. In these initial experiments, methyl cyclohexane or perhydrodibenzyltoluene—as a mixture of isomers (Compound 18H-MSH in the Mueller et al reference above), was used as the fuel 16, while oxygen 18 was used as the oxidant. The fuels preheated to 130° C. were introduced into an N2 stream that was passed through a bubble humidifier maintained at 130° C. prior to entering the anode compartment of the cell, the effluent from which was discharged at atmospheric pressure. An oxygen stream at 0.2 L/min was passed through a bubble humidifier at 80° C. before entering the cathode volume of the cell. At these conditions, methylcyclohexane (bp 101° C.) is expected to be mostly in the gas phase while perhydrodibenzyltoluene (bp 390° C.) will be predominantly in the liquid state. To activate the MEA, the fuel cell was operated at a current density of 0.2 A/cm² with an H₂ feed for about 3 hours until the expected OCV was reached. After the activation process, the polarization curve (cell voltage vs current density) at 160° C. was recorded at a scan rate of 5 mV/s.

### Example 5. Use of Methylcyclohexane, C₆H₅CH₃ as the Fuel

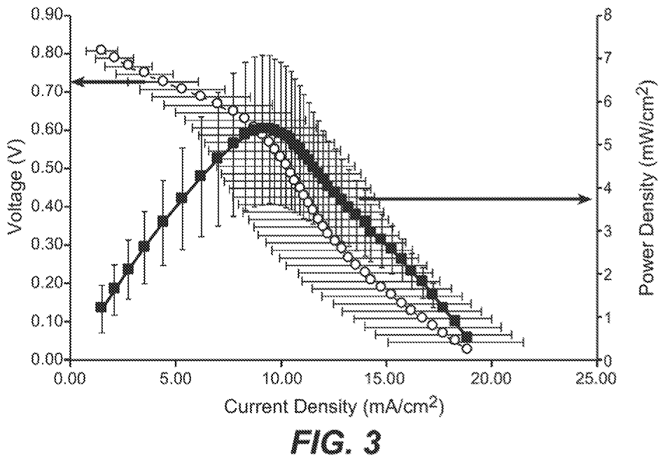

A stream of N₂ (gas) at 0.05 L/min, was passed through a bubble humidifier maintained at 130° C. and then mixed with vaporized methylcyclohexane at 130° C. before entering the anode compartment of the fuel cell 2. The best performance was realized by admitting the fluid to the cell's anode via regular serpentine flow channels and the use of Danish Power Systems' high temperature Pt/carbon electrodes optimized for phosphoric acid content. Operating temperatures were 130° C., 160° C. and 80° C. for the anode, cell and cathode, respectively. The performance of the cell as an average of three experimental runs, each of about six hours is reported as the polarization curve, shown in FIG. 3. This is a plot of cell Voltage vs. Current Density and cell Voltage vs. Power Density (voltage×current per active cell surface area). As for all fuel cells, the voltage is at a maximum at near zero current (the open cell voltage, OCV) then gradually diminishes with increasing load.

### Example 6. Use of Perhydrodibenzyltoluene, as the Fuel

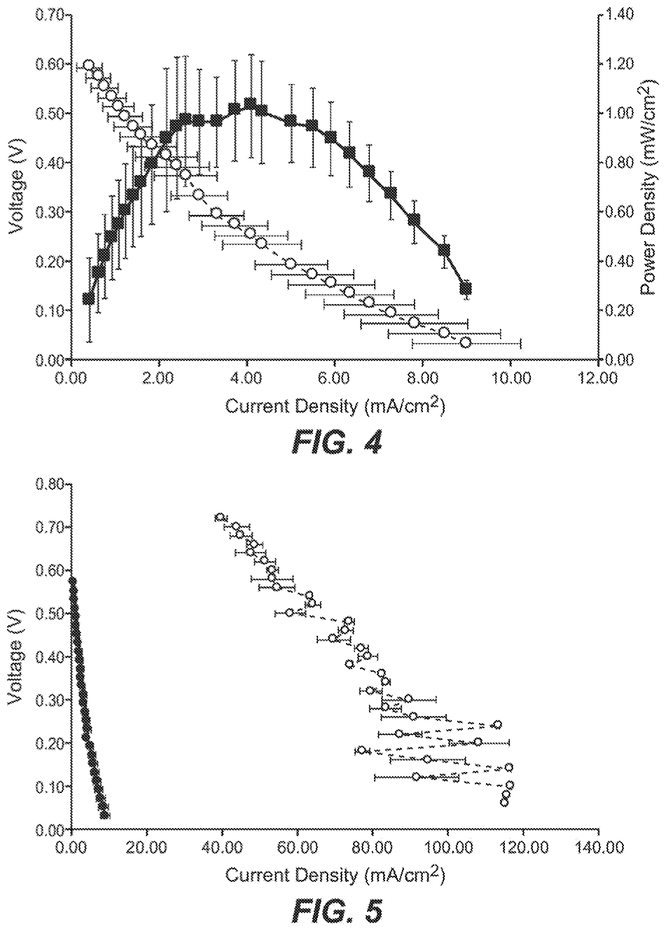

A stream of N₂ (gas) at 0.05 L/min, was passed through a bubble humidifier maintained at 130° C. combined with a 0.18 ml/min flow of liquid perhydrodibenzyltoluene (as a mixture of isomers) preheated to 130° C. and the mixture fed to the anode 12 compartment of the fuel cell. At this temperature perhydrodibenzyltoluene, (normal bp 390° C.) is expected to be mostly in the liquid phase. The fluid was admitted to the cell's anode via serpentine flow channels. Danish Power Systems” high temperature Pt/carbon electrodes optimized for phosphoric acid were used. Operating temperatures were 130° C., 160° C. and 80° C. for the anode, cell and cathode, respectively. The performance of the cell, as an average of three experimental runs, each over about six hours is reported as the polarization curve, shown as FIG. 4.

### Example 7. Perhydrodibenzyltoluene Fed FC with Improved Performance

A very recent FC run with perhydrodibenzyltoluene (as a mixture of isomers) was conducted under the same conditions as for Example 6 above, except that the feed liquid was now admitted to the anode compartment using parallel flow channels. Also, a carbon felt layer was used for increasing the in-cell perhydrodibenzyltoluene storage capacity. Results are provided as a polarization curve (only the Voltage vs Current Density) in FIG. 5. The cell Voltage vs Current Density plot is shown with the data points as open circles (O). As shown in FIG. 5, the cell voltage vs current data for perhydrodibenzyltoluene from the previous run—Example 6, is plotted as full circles, on the same ‘Current Density’ axis. From a comparison of this data with that in FIG. 4 (re-drawn as the plot seen at the left in FIG. 5) it's evident that there's been about an order of magnitude improvement in performance. (e.g., a current density of 100 mA/cm² vs 8 mA/cm², at 0.2V).

### Electrochemical Energy Conversion Device (ECD)

The ECD may be a fuel cell or a flow battery. Common to both electrochemical devices are anode and cathode electrodes which are separated by an ion conducting electrolyte. In a fuel cell, the anode and cathode are face-to-face in close proximity but separated by a solid electrolyte. In the flow battery, a liquid-phase electrolyte is re-circulated between the cathode and anode compartments of the cell.

Fuel cells are electrochemical cells which produce usable electricity by the catalyzed combination of a fuel such as hydrogen and an oxidant such as oxygen. Typical membrane electrode assemblies (MEA's) include a polymer electrolyte membrane (PEM) 10 (also known as an ion conductive membrane (ICM)), which functions as a solid electrolyte. One face of the PEM is in contact with an anode electrode layer 12 and the opposite face is in contact with a cathode electrode layer 14. In typical cells, protons are formed at the anode via oxidation of hydrogen or other fuel and transported across the PEM to the cathode to react with oxygen, thereby causing electrical current to flow in an external circuit connecting the electrodes. Each electrode layer includes electrochemical catalysts (anode catalyst 20 and cathode catalyst 22 in FIG. 2), typically including platinum metal. The PEM 10 forms a durable, non-porous, electrically non-conductive mechanical barrier between the reactant gases or liquids yet it also passes ions readily. Gas diffusion layers (GDL's) facilitate gas transport to and from the anode and cathode electrode materials and conduct electrical current. The GDL is both porous and electrically conductive, and is typically composed of carbon fibers. The GDL may also be called a fluid transport layer (FTL), enabling also the transport of a liquid, or a diffuser/current collector (DCC). In some embodiments, the anode and cathode electrode layers are applied to the MFEA are, in order: anode FTL, anode electrode layer, PEM, cathode electrode layer, and cathode GDL. In other embodiments, the anode and cathode electrode layers are applied to either side of the PEM and the resulting catalyst-coated membrane (CCM) is sandwiched between two GDL's to form a five-layer MEA.

The PEM 10 (FIG. 2), according to the present invention, may include any suitable polymer or blend of polymers. Typical polymer electrolytes bear anionic functional groups bound to a common backbone, which are typically sulfonic acid groups but may also include carboxylic acid groups, imide groups, amide groups, or other acidic functional groups. Polymer electrolytes, according to the present invention, may include functional groups which include polyoxometalates. The polymer electrolytes are typically fluorinated, more typically highly fluorinated, and most typically perfluorinated but may also be non-fluorinated. The polymer electrolytes are typically copolymers of tetrafluoroethylene and one or more fluorinated, acid-functional co-monomers. Typical polymer electrolytes include Nafion® (DuPont Chemicals, Wilmington Del.) and Flemion™ (Asahi Glass Co. Ltd., Tokyo, Japan). The polymer electrolyte may be a copolymer of tetrafluoroethylene (TFE) and FSO₂—CF₂CF₂CF₂CF₂—O—CF═CF₂, described in U.S. Publication No. 2004/0116742, U.S. Pat. Nos. 6,624,328 and 7,348,088. The polymer typically has an equivalent weight (EW) of 1200 or less, more typically 1100 or less, more typically 1000 or less, more typically 900 or less, and more typically 800 or less. Non-fluorinated polymers may include without limitation, sulfonated PEEK, sulfonated polysulfone, and aromatic polymers containing sulfonic acid groups.

In view of the relatively low tendency of the saturated hydrocarbon molecules of the fuels of the present invention to undergo dehydrogenation and partial oxidation, preferred are proton-conducting membranes which can function at higher temperatures than the ca. 80° C. of conventional hydrogen/air fuel cells, namely to temperatures of up to about 200° C. as for poly (2, 5-benzyimidazole) (PBI) polymer membranes (Asensio et al., J. Electrochem. Soc. 2004, 151(2), A304) doped with phosphoric acid, or with long chain perfluorosulfonic acids, which have been added (as their potassium salts) to phosphoric acid in phosphoric acid fuel cells (Gang, Bjerrum et al., J. Electrochem. Soc., 1993, 140, 896; Bjerrum, U.S. Pat. No. 5,344,722 (1984), vinylphosphonicacid/zirconium phosphate membranes (U.S. Pat. No. 8,906,270), and to even somewhat higher temperatures using inorganic-organic composite membranes (Zhang et al., J. of Power Sources 2006, 160, 872).

The polymer electrolyte membrane (PEM) can be formed into a membrane by any suitable method. The polymer is typically cast from a suspension. Any suitable casting method may be used, including bar coating, spray coating, slit coating, brush coating, and the like. Alternately, the membrane may be formed from neat polymer in a melt process such as extrusion. After forming, the membrane may be annealed, typically at a temperature of 120° C. or higher, more typically 1300° C. or higher, most typically 150° C. or higher. The PEM 10 (FIG. 4) typically has a thickness of less than 50 microns, typically less than 40 microns, more typically less than 30 microns, and most typically about 25 microns.

The polymer electrolyte membrane, according to the present invention may include polyoxometalates (POM's) or heteropoly-acids (HPA's) which as redox systems can potentially facilitate electron-transfer processes at the fuel cell's electrodes. Polyoxometalates are a class of chemical species that include oxygen-coordinated transition metal cations (metal oxide polyhedra), assembled into well-defined (discrete) clusters, chains, or sheets, wherein at least one oxygen atom coordinates two of the metal atoms (bridging oxygen). A polyoxometalate must contain more than one metal cation in its structure, which may be the same or different elements. Polyoxometalate clusters, chains, or sheets, as discrete chemical entities, typically bear a net electrical charge and can exist as solids or in solution with appropriately charged counterions. Anionic polyoxometalates are charge-balanced in solution or in solid form by positively charged counterions (countercations). Polyoxometalates that contain only one metallic element are called isopolyoxometalates. Polyoxometalates that contain more than one metal element are called heteropolyoxometalates. Optionally, polyoxometalates may additionally comprise a Group 13, 14, or 15 metal cation. Anionic polyoxometalates that include a Group 13, 14, or 15 metal cation (heteroatom), and that are charge-balanced by protons, are referred to as heteropolyacids (HPA). Heteropolyacids, where the protons have been ion-exchanged by other countercations, are referred as HPA salts or salts of HPA's.

In some embodiments of the present invention, polymer electrolytes are provided which incorporate polyoxometalates (POM's) and heteropolyacids (HPA's), which also provide some of the proton conductivity. The polyoxometalates and/or their counterions comprise transition metal atoms which may include tungsten and manganese, also cerium.

To make a membrane electrode assembly (MEA) or catalyst-coated membrane (CCM), the catalyst may be applied to a PEM by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

Any suitable catalyst may be used in the practice of the present invention. Typically, carbon-supported catalyst particles are used as the catalysts consisting of Pt, Ru, Rh and Ni and alloys thereof. Traditionally, the catalysts, as very small, nanoscale particles, are physically supported on the carbon. Typical carbon-supported catalyst particles are 50-90% carbon and 10-90% catalyst metal by weight, the catalyst metal typically including Pt for the cathode and Pt and Ru in a weight ratio of 2:1 for the anode.

Molecular catalysts including metal coordination compounds, also known as organo-metal complexes, may be covalently attached to the carbon surface, thus at least affording the maximum possible dispersion of metal, usually with some of the complexes' remaining ligands. In a direct methane fuel cell, an unprecedented catalytic activity was seen for an electrochemical oxidation of carbon-hydrogen bonds by platinum organo-metal complexes covalently tethered through their organic ligands to ordered mesoporous carbons. (Joglekar, et al., J. Am. Chem. Soc. 2016, 138, 116. The MEA's and Pt organometal complex catalysts employed in this work should be applicable towards realizing an electrochemical dehydrogenation and/or partial oxidation of the somewhat less refractory C—H bonds of the cycloalkane ring, and of the substituent alkyl groups of the fuel of this present invention. Other electrocatalysts that may be useful for activating C—H bonds at the anode of the cell include nickel and combinations of the Pt Group metals (Ru, Os, Rh, Ir and Pd, Pt) or gold, with copper oxide (CuO) and other redox oxides—such as vanadium oxide (V₂O₅), as employed, for example on an electrically-conducting tin oxide support as the anode catalyst. (Lee et al., J. of Catalysis 2011, 279, 233.)

Typically, the catalyst is applied to the PEM or to the fluid transport layer (FTL) in the form of a catalyst ink. Alternately, the catalyst ink may be applied to a transfer substrate, dried, and thereafter applied to the PEM or to the FTL as a decal. The catalyst ink typically includes polymer electrolyte material, which may or may not be the same polymer electrolyte material which comprises the PEM. The catalyst ink typically includes a dispersion of catalyst particles in a dispersion of the polymer electrolyte. The ink typically contains 5-30% solids (i.e., polymer and catalyst) and more typically 10-20% solids. The electrolyte dispersion is typically an aqueous dispersion, which may additionally contain alcohols and polyalcohols such a glycerin and ethylene glycol. The water, alcohol, and polyalcohol content may be adjusted to alter rheological properties of the ink. The ink typically contains 0-50% alcohol and 0-20% polyalcohol. In addition, the ink may contain 0-2% of a suitable dispersant. The ink is typically made by stirring with heat followed by 20-fold dilution to a coatable consistency.

To make an MEA, gas diffusion layers (GDLs) may be applied to either side of a catalyst-coated membrane (CCM) by any suitable means. Any suitable GDL may be used. Typically, the GDL includes a sheet material including carbon fibers. Typically, the GDL is a carbon fiber construction selected from woven and non-woven carbon fiber constructions. Carbon fiber constructions which may be useful may include: TORAY™ Carbon Paper, SPECTRACARB™ 35 Carbon Paper, AFN™ non-woven carbon cloth, ZOLTEK™ Carbon Cloth, and the like. The GDL may be coated or impregnated with various materials, including carbon particle coatings, hydrophilizing treatments, and hydrophobizing treatments such as coatings with polytetrafluoroethylene 40 (PTFE) or tetrafluoroethylene copolymers such as FEP.

In use, the MEA, according to the prior art, are typically sandwiched between two rigid plates, known as distribution plates, also known as bipolar plates (BPP's) or monopolar plates. Like the GDL, the distribution plate must be electrically conductive. The distribution plate is typically made of a carbon composite, metal, or plated metal material. The distribution plate distributes reactant or product fluids to and from the MEA electrode surfaces, typically through one or more fluid-conducting channels engraved, milled, molded or stamped in the surface(s) facing the MEA(s). These channels are sometimes designated as a flow field and may be of various designs, such a set of parallel channels, a serpentine pathway for the fluid or more complex patterns. Liquid fed fuel cells often employ a single manifold into a porous media such as a metal sponge or carbon felt. In a toluene-methylcyclohexane electrochemical hydrogenation device the use of a carbon paper flow field/diffusion layer resulted in a much better performance of the cell than when parallel, serpentine, or interdigital flow fields for introducing the liquid feed were employed. (Nagasawa, Electrochimica Acta (in press) http://dx.doi.org/doi:10.1016/j.electacta.2017.06.081Reference: EA 29719)

The distribution plate may distribute fluids to and from two consecutive MEA's in a stack, with one face directing fuel to the anode of the first MEA while the other face directs oxidant to the cathode of the next MEA (and removes product water). A typical fuel cell stack includes a number of MEA's stacked alternately with distribution plates.

### Electrochemical Energy Conversion System

The Electrochemical Energy Conversion System is shown schematically in FIG. 2. The electrochemical device 2 is outlined as a fuel cell with the membrane electrode assembly (MEA) as its central feature. Represented at the left is a storage tank 24 that contains both the fresh fuel 16 and the spent fuel liquids 26 which are separated by a flexible diaphragm or bladder 28. Additionally, there is a reservoir 30 for feeding water to the anode compartment 12 that could be used as needed as a reagent when the electrochemical partial oxidation leads to and introduction of oxygen. (ref. Equation 3) As shown, the cell 2 is consuming fuel and generating electricity under a load 32. When operating in a fuel regeneration mode, the cell 2 runs in reverse with now an input of electricity in place of the load.

A fueling and refueling of the tank 24 could be conveniently performed as a single operation using a dual nozzle fuel pump as detailed in US Patent Publication No. 2005/0013767.

The system outlined herein may be used for either stationary or vehicular energy storage using the well-established hydrocarbon fuels infrastructure for delivery but now reconfigured for also a return of the spent fuel 26 to a central processing facility for its regeneration via a catalytic hydrogenation process. A regeneration of the fuel by the electrolysis option, i.e., by running the fuel cell in reverse would be particularly advantageous in locations where solar-derived electricity is available. Systems operating in this electrical regeneration mode would be ideal for electrical load levelling. The fuels of this present invention are expected to be stable over long periods especially when stored under a relatively inert (non-oxidizing) atmosphere and would be ideal for use in seasonal storage applications—with the potential, among other advantages, of a higher energy storage density than the LOHC's and associated systems of the prior art (as described by Newson et al., Int. J. Hydrogen Energy 1998, 23(10), 905).

Wind and solar farms are inherently transient generators of electricity. In the electrical regeneration mode, the storage systems of this present invention could be employed as electrical energy buffers, thus bridging over the day to night power demands, and of the “windless” periods of operation of these energy sources. It is envisioned that a portion—or even a major part of the generated and stored energy-rich liquid fuel, would be introduced into a liquids transport infrastructure for transport to stationary energy storage “hubs” from which deliveries are made to local or vehicular consumers. The “spent” fuel 26 (FIG. 2) would be returned via the same transport infrastructure where it is reconstituted either electrically or with hydrogen that is preferably derived from water electrolysis using renewably generated power.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety.

The applicant reserves the right to physically incorporate into this specification any and all materials and information from any such patents, publications, scientific articles, web sites, electronically available information, and other referenced materials or documents to the extent such incorporated materials and information are not inconsistent with the description herein.

The written description portion of this patent includes all claims. Furthermore, all claims, including all original claims as well as all claims from any and all priority documents, are hereby incorporated by reference in their entirety into the written description portion of the specification, and Applicant(s) reserve the right to physically incorporate into the written description or any other portion of the application, any and all such claims. Thus, for example, under no circumstances may the patent be interpreted as allegedly not providing a written description for a claim on the assertion that the precise wording of the claim is not set forth in haec verba in written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended and those skilled in the art will recognize, that the invention embraces and is also thereby described in terms of any individual member or subgroup of members of the Markush group.

Other embodiments are within the following claims. Therefore, the patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Other modifications and implementations will occur to those skilled in the art without departing from the spirit and the scope of the invention as claimed. Accordingly, the description hereinabove is not intended to limit the invention, except as indicated in the appended claims.

What is claimed is:

1. A method of directly converting chemical energy into electrical energy using an electrochemical energy conversion device having a membrane electrode assembly (MEA), the method comprising the steps of:
providing an electrochemical energy conversion device having a membrane electrode assembly (MEA), wherein the membrane electrode assembly comprises a cathode and an anode, which are separated by a proton conducting membrane and wherein each cathode and anode includes a catalyst;
connecting a liquid fuel to the membrane electrode assembly (MEA) such that the liquid fuel is in fluid communication with the membrane electrode assembly (MEA), and wherein the liquid fuel comprises methyl cyclohexane, ethylcyclohexane, a mixture of isomers of perhydrogenated xylenes, or random isomeric mixtures of alkylated hydrogenated aromatic molecules of two or more six-membered rings, wherein a selective electrochemical oxidation of the fuel, in the presence of a stoichiometric quantity of a supplied water co-reactant comprises a conversion of an alkyl substituent group on a cycloalkane or on an aromatic hydrocarbon molecule product to an alcohol, aldehyde, ketone or carboxylic acid group product;
connecting a water source to the membrane electrode assembly (MEA) such that, wherein the water source is in fluid communication with the anode for supplying the stoichiometric quantity of water needed to the membrane electrode assembly (MEA) for the conversion of the liquid fuel;
connecting a source of an oxidant to the membrane electrode assembly (MEA) such that the source of an oxidant is in fluid communication with the cathode of the membrane electrode assembly (MEA);
contacting the membrane electrode assembly with the liquid fuel with, thereby converting chemical energy into electrical energy;
operating the conversion of chemical energy to electrical energy at a temperature between about 80 and about 220° C.; and
connecting a collector to the anode of the membrane electrode assembly (MEA) for collecting a converted fuel effluent from the membrane electrode assembly (MEA).

2. The method of directly converting chemical energy into electrical energy using a membrane electrode assembly (MEA), according to claim 1, wherein the catalyst for the anode and the catalyst for the cathode is independently selected from the group consisting of:
palladium, platinum, iridium, rhodium, ruthenium, nickel and combinations thereof.

3. The method of directly converting chemical energy into electrical energy using a membrane electrode assembly (MEA), according to claim 1, wherein the catalyst for the anode and the catalyst for the cathode comprises a metal coordination compound that is tethered to a carbon support, wherein the metal coordination compound is independently selected from the group consisting of:
palladium, platinum, iridium, rhodium, ruthenium, and nickel.

4. The method of directly converting chemical energy into electrical energy using a membrane electrode assembly (MEA), according to claim 1, wherein the membrane comprises a material selected from the group consisting of:
a polymer functionalized with a heteropoly acid, sulfonated polymer, phosphonated polymer, proton conducting ceramic, polybenzimidazole (PBI), combinations of polybenzimidazole and phosphoric acid, combinations of polybenzimidazole, phosphoric acid, and a heteropoly acid, and combinations of polybenzimidazole, a long chain perfluorosulfonic acid, and a heteropoly acid.

5. A method of directly converting chemical energy into electrical energy using an electrochemical energy conversion device, the method comprising the steps of:
providing an electrochemical energy conversion device having an anode and a cathode, in fluid communication with a source of a hydrogen or electrochemically-regenerable liquid fuel;
connecting a water source to the electrochemical energy conversion device such that the water source is in fluid communication with the anode;
connecting a source of an oxidant to the electrochemical energy conversion device such that the source of an oxidant is in fluid communication with the cathode, wherein the electrochemical energy conversion device receives, catalyzes, dehydrogenates and electrochemically oxidizes at least a portion of the hydrogen or electrochemically-regenerable liquid fuel and water to generate electricity;
wherein as a result of the electrochemical energy conversion device receiving, catalyzing, dehydrogenating and electrochemically oxidizing at least the portion of the hydrogen or electrochemically-regenerable liquid fuel and the water, a resultant liquid is formed which comprises the at least partly oxidatively electrochemically dehydrogenated and electrochemically partially oxidized liquid fuel and water,
wherein the hydrogen or electrochemically-regenerable liquid fuel is a composition comprising 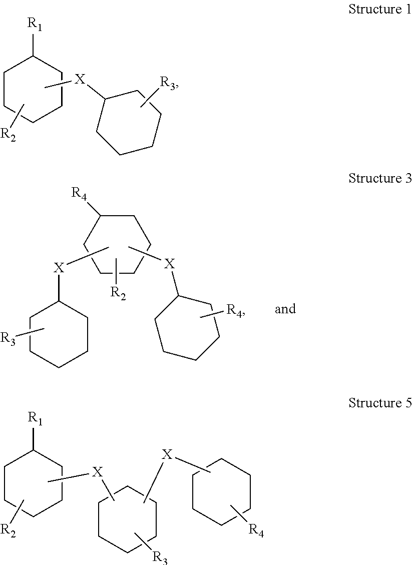
wherein R₁-R₄ are C₁-C₆ alkyl groups,
wherein X is selected from the group consisting of methylene, ethan-1,2-diyl, propan-1,3-diyl, propan-1,2-diyl, oxide and direct carbon-carbon linkages,
wherein at least one to four of the R₁ to R₄ substituents may be present such that for each structure 1, 3 and 5, at least R₁ is present;
wherein the electrochemical partial oxidation of the hydrogen or electrochemically-regenerable liquid fuel and the water comprises a conversion of an alkyl substituent group on a cycloalkane ring or on an aromatic molecule product to an alcohol, aldehyde, ketone or carboxylic acid group product with the water as a co-reagent that is supplied by the water source in at least a stoichiometric quantity for converting the hydrogen or electrochemically-regenerable liquid fuel; and
connecting a collector to the anode of the electrochemical energy conversion device for collecting a converted fuel effluent from the electrochemical energy conversion device.

6. The method of directly converting chemical energy into electrical energy using an electrochemical energy conversion device, according to claim 5, wherein the hydrogen or electrochemically-regenerable liquid fuel is a liquid mixture comprising two or more compounds selected from a mix of different isomers of ring-hydrogenated benzyltoluene and a mix of different isomers of ring-hydrogenated dibenzyltoluene.

7. The method of directly converting chemical energy into electrical energy using an electrochemical energy conversion device, according to claim 5, wherein the electrochemically at least partly oxidatively dehydrogenated liquid fuel comprises a mixture of two or more compounds selected from a mix of different isomers of benzyltoluene and a mix of different isomers of dibenzyltoluene.

8. A method of directly converting chemical energy into electrical energy using an electrochemical energy conversion device, the method comprising the steps of:
providing an electrochemical energy conversion device having an anode and a cathode, in fluid communication with a source of a hydrogen or electrochemically-regenerable liquid fuel;
connecting a water source to the electrochemical energy conversion device such that the water source is in fluid communication with the anode;
connecting a source of an oxidant to the electrochemical energy conversion device such that the source of an oxidant is in fluid communication with the cathode, wherein the electrochemical energy conversion device receives, catalyzes, dehydrogenates and electrochemically oxidizes at least a portion of the hydrogen or electrochemically-regenerable liquid fuel and water to generate electricity;
wherein as a result of the electrochemical energy conversion device receiving, catalyzing, dehydrogenating and electrochemically oxidizing at least the portion of the hydrogen or electrochemically-regenerable liquid fuel and the water, a resultant liquid is formed which comprises the at least partly oxidatively electrochemically dehydrogenated and electrochemically partially oxidized liquid fuel and water;
wherein the hydrogen or electrochemically-regenerable liquid fuel is a composition comprising methylcyclohexane, ethylcyclohexane, or a mixture of isomers of perhydrogenated xylenes,
wherein the electrochemical dehydrogenation and partial oxidation of the hydrogen or electrochemically-regenerable liquid fuel and the water comprises a conversion of the alkyl substituent group on a cycloalkane ring of the liquid fuel or on the ring—dehydrogenated aromatic molecule product to an alcohol, aldehyde, ketone or carboxylic acid group product with the water as a co-reagent that is supplied by the water source in at least a stoichiometric quantity for converting the hydrogen or electrochemically-regenerable liquid fuel; and
connecting a collector to the anode of the electrochemical energy conversion device for collecting a converted fuel effluent from the electrochemical energy conversion device.

9. The method of directly converting chemical energy into electrical energy using an electrochemical energy conversion device, according to claim 8, wherein the electrochemical energy conversion device is a proton-exchange electrolyte membrane (PEM) fuel cell, comprising the anode, the cathode, and a proton conducting membrane.

10. The method of directly converting chemical energy into electrical energy using an electrochemical energy conversion device, according to claim 9, wherein the electrochemical energy conversion system further comprises a catalyst which is disposed within the electrochemical energy conversion device for assisting in the electrochemical oxidation of the hydrogen or electrochemically-regenerable liquid fuel.

11. The method of directly converting chemical energy into electrical energy using an electrochemical energy conversion device, according to claim 9, wherein the catalyst is selected from a group consisting of:
palladium, platinum, iridium, rhodium, ruthenium, nickel and combinations thereof.

12. The method of directly converting chemical energy into electrical energy using an electrochemical energy conversion device, according to claim 9, wherein the catalyst comprises a metal coordination compound that is tethered to a carbon support, wherein the metal may be selected from a group consisting of:
palladium, platinum, iridium, rhodium, ruthenium, and nickel.

13. The method of directly converting chemical energy into electrical energy using an electrochemical energy conversion device, according to claim 8, wherein the proton-exchange membrane is selected from the group consisting of:
sulfonated polymers, phosphonated polymers and inorganic-organic composite materials.

14. The method of directly converting chemical energy into electrical energy using an electrochemical energy conversion device, according to claim 8, wherein the proton-exchange membrane is selected from the group consisting of:
poly (2,5-benzyimidazole) (PBI), combinations of poly(2,5-benzimidazole) and phosphoric acid, combinations of poly(2,5-benzimidazole) with a long chain perfluoroalkylsulfonic acid, and combinations of poly(2,5-benzimidazole) with phosphoric acid and a heteropolyacid.

15. The electrochemical energy conversion system, according to claim 10, wherein a mesoporous carbon-tethered platinum metal complex catalyst is employed at the anode of the electrochemical energy conversion device.
